(19) United States
(12) Patent Application Publication
(10) Pub. No.: US 2022/0107182 A1
(43) Pub. Date: Apr. 7, 2022

(54) LOCATING METHOD

(71) Applicants: HARDIS GROUPE, SEYSSINET-PARISET (FR); SQUADRONE SYSTEM, GRENOBLE (FR)

(72) Inventors: Charles COLAS, GRENOBLE (FR); Pierre AVANZINI, VOREPPE (FR)

(21) Appl. No.: 17/426,204

(22) PCT Filed: Jan. 28, 2020
(86) PCT No.: PCT/FR2020/050127

§ 371 Date: Jul. 28, 2021

(30) Foreign Application Priority Data
Jan. 28, 2019 (FR) 1900750

(51) Int. Cl. G01C 21/00; G01C 21/20; B60W 40/10

(52) U.S. Cl. CPC G01C 21/005; G01C 21/20; B60W 40/10; B60W 2556/50; B60W 2520/06; B60W 2554/20; B60W 2554/802; B60W 2420/52

(57) ABSTRACT

The invention relates to a localization method for a vehicle (1) moving in the vicinity of a wall (20a, 20b), with a localization frame of reference, defined at the point of projection of the vehicle (1) on the wall (20a, 20b), comprising a horizontal longitudinal axis (Y) tangent to the wall (20a, 20b) and a vertical axis (Z), a transverse axis (X) being defined such that the frame of reference is a direct orthonormal frame of reference. Moreover, the method comprises localization along the transverse axis (X) on the basis of measurements of a distance between the vehicle (1) and the wall (20a, 20b) provided by at least one transverse distance sensor (15a, 15b) of the vehicle (1), and localization along the longitudinal axis (Y) on the basis of measurements of a distance between the vehicle (1) and a fixed terminal (21) provided by at least one longitudinal distance sensor (16) of the vehicle (1).

### FIELD OF THE INVENTION AND PRIOR ART

The invention relates to the field of localization and navigation of a vehicle.

It is known that, in order to control a vehicle such as a flying drone, a wheeled mobile vehicle or a watercraft, and thus also to perform automated navigation tasks, it is necessary to be able to localize the vehicle in its environment.

In general, the localization for this type of vehicle is carried out by combining data from proprioceptive sensors and feeding this into an evolution model, with data from exteroceptive sensors providing raw localization data.

This generally involves the use of an inertial unit (or odometers in the case of a wheeled mobile vehicle) acting as proprioceptive sensors, and a raw localization given jointly by a “Global Positioning System” device, which calculates the position and speed of the vehicle, and magnetometers, which make it possible to determine the yaw of the vehicle (i.e. its orientation about a vertical axis).

Unfortunately, in an indoor environment the use of a GPS is impossible because the signals are masked (or at best significantly deteriorated). Likewise, the use of magnetometers is ineffective because the magnetic environment can be significantly disturbed.

Several alternatives have been considered for navigating a vehicle in an indoor environment.

The most traditional method is to use a precision inertial unit, i.e. a set of accelerometers and gyroscopes that are sufficiently reliable to allow a localization to be deduced. However, precision inertial units are bulky, heavy and expensive (and therefore unsuitable for lightweight drones). In addition, if it is mounted on a drone, the inertial unit will be particularly sensitive to the vibrations caused by the movement of the vehicle, generating an unacceptable drift in the estimation of the localization.

Another method, specially adapted to lightweight drones, is to use a device combining a gyroscope, an altitude sensor and a ground-facing camera, hereinafter referred to as an optical flow sensor. This returns a speed of movement in the plane normal to the optical axis of the camera (generally the ground plane) with an accuracy which depends in particular on the altitude of the vehicle and the angle of view of the camera.

However, it has been found that the use of an optical flow sensor does not make it possible to obtain the servo performance, for “fine” operations, required in the context of navigation in logistics aisles. Indeed, an accuracy of less than 10 cm and 0.05 m/s is required, respectively, for the position of the vehicle and its speed in order to scan the barcodes of products stored in a warehouse:
the sensor measures speeds in the horizontal plane and does not allow the position of the vehicle to be recalibrated, which ends up drifting in time
the lens of the camera is selected so as to give good results at a given altitude. Logistics aisles are generally high (more than ten meters high) and it is not possible to obtain accurate speed estimates over the whole of this altitude range from the same perspective.

Another solution consists in equipping the navigation space with beacons which can provide either distance information (radio communication with the vehicle, for example), or information deduced from their perception by the vehicle, which is then equipped with an appropriate sensor (e.g. a camera if it is a visual beacon). In principle, the localization improves if the beacons are well distributed in the navigation space.

The main drawback of this solution is that it requires equipping the environment and accurately estimating the position of the beacons beforehand. Also, in the case of navigation in a logistics aisle, the beacons would be confined to a corridor and the distance between the vehicle and the partitions (i.e. the positioning relative to a transverse axis normal to the partitions) would not be accurate.

Another solution involves drawing up an environmental map. This can be done before or during navigation (known as SLAM, “Simultaneous Localization And Mapping”). This method requires processing a large amount of information (images, laser sheets, etc.), and requires a significant computing capacity to be loaded and does not guarantee the accuracy of the representation of the environment thus generated. The resulting map is then intended to be stored and reused during subsequent navigations in order to localize the vehicle. However, in the case of navigation in a logistics aisle, the environment changes regularly (movement of pallets) and is repeated (many identical pallets/structures). There is thus no guarantee that the map will always be relevant for localization once the environment has been changed. The value of having a map therefore seems limited in view of the imposed constraints.

### General Presentation of the Invention

In this context, the object of the present invention is to provide a localization method for a vehicle in the vicinity of a wall, which makes it possible to precisely position the vehicle relative to the wall and relative to a fixed terminal placed in an arbitrary manner in the navigation space, so that the vehicle can perform precise operations such as scanning barcodes, without using expensive elements.

According to a first aspect, the invention relates to a localization method for a vehicle moving in the vicinity of a wall, with a localization frame of reference, defined at the point of projection of the vehicle on the wall, comprising a horizontal longitudinal axis tangent to the wall, a vertical axis and a transverse axis defined such that the frame of reference is a direct orthonormal frame of reference. The method comprises localization along the transverse axis on the basis of measurements of a distance between the vehicle and the wall provided by at least one transverse distance sensor of the vehicle, and localization along the longitudinal axis on the basis of measurements of a distance between the vehicle and a fixed terminal provided by at least one longitudinal distance sensor of the vehicle.

The use of such a representation of the localization, linked to the wall, very advantageously makes it possible to ensure precise positioning by dispensing with a relative movement calculation, in which the localization would be obtained at each moment by estimating the movement carried out since the previous localization, and which would naturally be subject to a drift phenomenon induced by the accumulation of errors. Indeed, the wall is a tangible, reliable and substantially immobile landmark. Thus, unlike known devices which rely solely on an estimation of the relative movement of the vehicle, the method according to the invention makes it possible to simply and precisely localize a vehicle relative to the wall and to a fixed terminal placed in an arbitrary manner in the navigation space.

Thus, the method according to the invention makes it possible to localize the vehicle on the basis of reliable data collected by exteroceptive sensors which provide measurements in the frame of reference linked to the wall.

Thus, the invention proposes a localization method for a vehicle in the vicinity of a wall, which makes it possible to precisely position the vehicle relative to the wall and to a fixed terminal so that it can perform precision operations such as scanning barcodes, without the need for expensive and complex elements.

The localization method may further comprise localization along the vertical axis on the basis of altitude measurements provided by altitude measuring means of the vehicle and/or vertical distance measurements from the ceiling provided by vertical distance measuring means.

The localization method may further comprise determining an orientation of the vehicle relative to the wall along the vertical axis by comparing the distance measurements between the vehicle and the wall provided by at least two transverse distance measurements of the vehicle obtained at different positions or in different orientations.

Each transverse distance measurement can be obtained using a sonar or a laser or a depth camera.

Said at least one longitudinal distance sensor may be an ultra-wideband sensor or a time-of-flight measurement system communicating with said fixed terminal.

The altitude measuring means of the vehicle can comprise at least one vertical distance sensor which measures the distance between the vehicle and the floor and/or the ceiling, and/or a barometer.

The localization along an axis from among the transverse axis, the longitudinal axis or the vertical axis can also be based on inertial data provided by an inertial unit of the vehicle.

The localization along a pair of axes from among the transverse axis, the longitudinal axis or the vertical axis can also be based on visual data provided by a camera of the vehicle, such as an optical flow sensor.

The vehicle can move in the vicinity of at least two opposing walls, including a first wall and a second wall, with the localization along the transverse axis being based on distance measurements between the vehicle and the first wall provided by at least one first transverse distance sensor of the vehicle, and/or distance measurements between the vehicle and the second wall provided by at least one second transverse distance sensor of the vehicle.

The vehicle can move under a wall which is opposite a floor and forms a ceiling, with the localization along the vertical axis being based on altitude measurements provided by altitude measuring means of the vehicle and/or vertical distance measurements from the ceiling provided by vertical distance measuring means.

According to another aspect, the invention relates to a navigation method for a vehicle which comprises localization of the vehicle according to the invention, and generation of a command to move the vehicle.

Said movement command can comprise a correction of the orientation of the vehicle so as to have only translational movements.

According to another aspect, the invention relates to a vehicle suitable for implementing a method according to the invention.

The vehicle can be selected from a flying drone, a wheeled mobile vehicle, or a mobile watercraft.

According to another aspect, the invention relates to a computer program product comprising code instructions for executing a localization method according to the invention and/or for executing a navigation method according to the invention, in order to allow the localization and/or navigation of a vehicle when the program is executed on a computer.

According to another aspect, the invention relates to a storage means which is readable by computer equipment and on which a computer program product comprises code instructions for executing a localization method according to the invention and/or for executing a navigation method according to the invention.

### DESCRIPTION OF THE FIGURES

Other features and advantages of the invention will become apparent from the following description, which is purely illustrative and non-limiting, and should be read in conjunction with the appended figures, in which:

FIG. 1 shows a diagram of a vehicle according to the invention along a wall;

FIG. 2 shows a diagram of a vehicle according to the invention between two walls;

FIG. 3 shows a block diagram of a navigation method according to the invention;

FIG. 4 schematically shows different geometries and configurations of walls.

FIG. 5 schematically shows different geometries and configurations of walls.

FIG. 6 schematically shows different geometries and configurations of walls.

FIG. 7 schematically shows different geometries and configurations of walls.

FIG. 8 schematically shows different geometries and configurations of walls.

FIG. 9 schematically shows different geometries and configurations of walls.

### DETAILED DESCRIPTION OF THE INVENTION

### Environment

The invention relates to the localization and navigation of a vehicle 1 indoors, in the vicinity of a wall 20a or 20b or between multiple walls 20a and 20b.

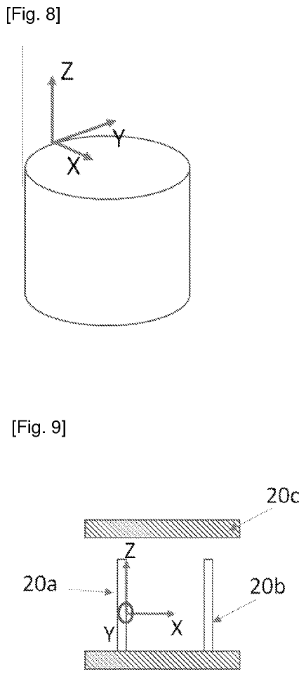

Typically, the environment in which the vehicle 1 operates may be a logistics warehouse comprising a plurality of aisles. Each aisle is delimited by at least one vertical wall 20a, 20b, that is to say rising more or less flatly and regularly relative to a surface forming a floor, and possibly by a ceiling 20c opposite the floor (see FIG. 8). The wall 20a, 20b can be defined by a wall or by a shelf, for example.

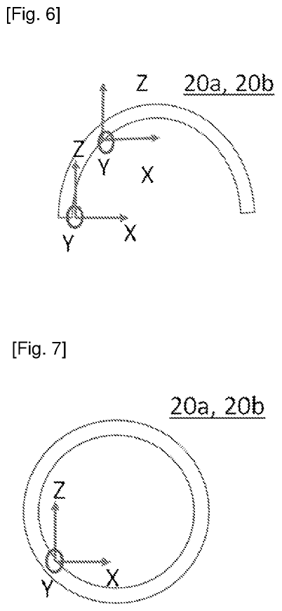

It should be noted that, as shown in FIGS. 4 to 9, the wall 20a, 20b can have various geometries. Thus, the walls 20a, 20b may be a perforated vertical structure, such as a shelf in a logistics warehouse (cf. FIG. 4), for example. With respect to FIG. 5, the wall 20a, 20b, can have curves and undulations. As shown in FIGS. 6 to 8, the wall 20a, 20b can be substantially semi-cylindrical or cylindrical, in the case of a tunnel (road, rail, metro, etc.), a pipe (e.g. of a sewer), a silo or an aircraft cabin, for example. Of course, these examples are non-limiting and serve only to illustrate the variety of possible geometries of the wall 20a, 20b.

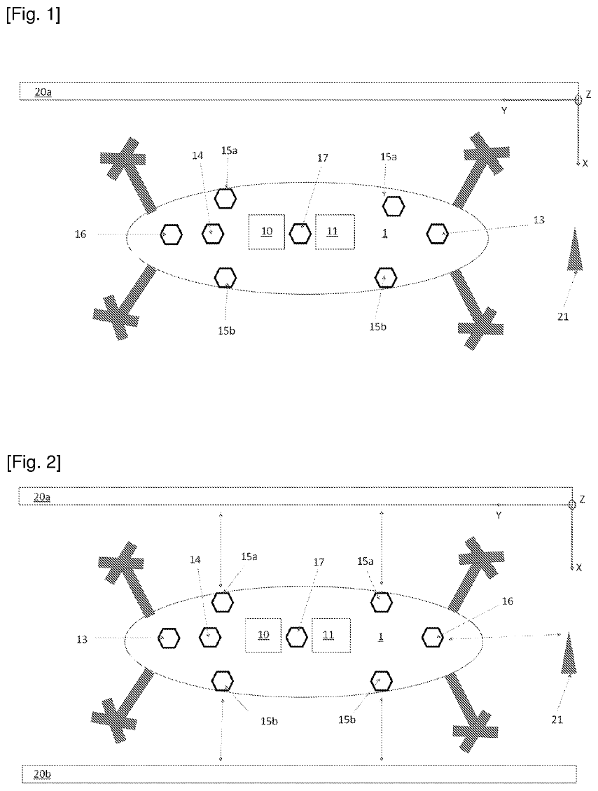

Said wall 20a, 20b defines a frame of reference, at the point of projection of the vehicle 1 on the wall 20a, 20b, with a longitudinal axis Y, which is horizontal and tangent to the wall 20a, 20b, a vertical axis Z, and a transverse axis X so that the frame of reference is a direct orthonormal frame of reference. This frame of reference is shown in FIGS. 1 to 2 and 4 to 9.

It will therefore be understood that, in this frame of reference, in the example of a logistics aisle, a longitudinal progression is a progression in the aisle along the wall 20a, 20b. A vertical progression is a variation in altitude and a transverse progression is a movement away from or toward the wall 20a, 20b.

As will be seen below, there can be two parallel walls 20a and 20b (typically in the case of a logistics aisle or tunnel), and it is then sufficient for the vehicle to move between the walls 20a, 20b (i.e. along each of the two walls 20a, 20b) in a perception space defined by sensors.

In addition, the orthogonal frame of reference used, which corresponds to the point of projection of the vehicle 1 on the wall 20a, 20b, is a sliding frame of reference (referred to as a Frenet frame of reference). A sliding frame of reference means that the frame of reference is not fixed in space but is moved according to the movements of the vehicle 1. Typically, as will be detailed below, the Frenet frame of reference is in this case moved along the wall 20a, 20b so that, locally, the vehicle 1 is always normal to the X axis.

### Vehicle

Preferably, the vehicle 1 is a flying vehicle, of the drone type. It is understood that such a vehicle is mobile in six degrees of freedom (three degrees of freedom in position along the three axes X, Y and Z, and three degrees of freedom in rotation about the axes X, Y and Z).

According to other embodiments, the vehicle 1 could be a mobile vehicle with wheels, and in this case it would not be driven along the vertical axis Z. The present method is suitable for any vehicle 1 intended to move along the wall 20a, 20b, i.e. to remain in the vicinity of this wall.

In a known manner, a vehicle 1 of the drone type can comprise a set of motors and propellers which allow it to fly and move in multiple directions in space. The vehicle 1 can comprise four or six propellers, for example. These known configurations make it possible to ensure both good stability and good handling of the vehicle 1. In addition, the vehicle 1 is preferably supplied with electrical energy and therefore carries one or more batteries.

In addition, the vehicle can comprise a control unit 10 and an inertial unit 11 comprising, as standard, three gyrometers which measure the three components of an angular velocity vector (it should be noted that, conventionally, roll is used to define rotation about the transverse axis X, pitch is used to define rotation about the longitudinal axis Y and yaw is used to define rotation about the vertical axis Z). In addition, the inertial unit 11 comprises three accelerometers which measure the three components of a specific force vector along the three axes X, Y and Z. It should be noted that the specific force corresponds to the sum of the external forces.

In addition, the vehicle 1 comprises altitude measuring means 13, 14, which can advantageously comprise a vertical distance sensor 13, for measuring the distance along the vertical axis Z (from the floor and/or the ceiling 20c) and/or a barometer 14.

As will be detailed below, the vertical distance sensor 13 and the barometer 14 can advantageously be combined so as to have a redundant determination of the altitude, or they can be used independently of one another.

Advantageously, as will be described below, the use of the vertical distance sensor 13 can be combined with an optical flow sensor 17.

The vehicle 1 comprises at least one transverse distance sensor 15a, 15b suitable for measuring a distance along the transverse axis X. This sensor is preferably a sonar. Advantageously, as will be described below, the use of the transverse distance sensor 15a, 15b can be combined with an optical flow sensor 17. 15a and 15b respectively denote sensors on one side or the other of the vehicle 1, i.e. intended for measuring the distance from a “left” or “right” wall. It will be understood that, for convenience, it is preferable that each vehicle comprises sensors 15a, 15b on both sides, but it is possible that only those on one side (the side of the wall 20a, 20b) will be used. Each sensor 15a, 15b is preferably a sonar.

In a particularly advantageous manner, the vehicle 1 comprises a plurality of transverse distance sensors 15a and/or 15b on the same side. As will be specified below, this arrangement makes it possible to measure the yaw of the vehicle 1, i.e. its orientation with respect to the wall 20a, 20b about the vertical axis Z.

Advantageously, as will be described below, the use of the transverse distance sensor 15a, 15b can be combined with an optical flow sensor 17.

The vehicle 1 can comprise a longitudinal distance sensor 16 suitable for measuring the position on the longitudinal axis Y. Said longitudinal distance sensor 16 can be an ultra-wideband (UWB) sensor. According to a preferred arrangement, the ultra-wideband sensor communicates with one or more fixed terminals 21. For example, in the case of navigation in a logistics aisle, there may be a terminal at each end of the aisle. In the case of a tunnel, it is possible to have terminals 21 at regular intervals, for example.

Advantageously, as will be described below, the use of the longitudinal distance sensor 16 can be combined with an optical flow sensor 17.

All measured quantities are advantageously measured at a sampling rate dt (i.e. every “dt” seconds), with dt being very small compared to the characteristic time of the movements of the vehicle 1, typically 20-200 ms.

It will be understood that the vehicle 1 can continue to localize itself despite the loss of a sensor.

### Localization Method

The invention relates to a localization method for the vehicle 1, which moves along the vertical wall 20a, 20b.

In a particularly advantageous manner, the localization method comprises positioning along three axes:
The position along the transverse axis X is based on measurements of a distance between the vehicle 1 and the wall 20a, 20b provided by at least one transverse distance sensor 15a, 15b of the vehicle 1.
The position along the longitudinal axis Y is based on measurements of a distance between the vehicle 1 and a fixed terminal 21 provided by at least one longitudinal distance sensor 16 of the vehicle 1.
The position along the vertical axis Z is based on altitude measurements provided by the altitude measuring means 13, 14 of the vehicle 1.

This is a particularly advantageous arrangement of the invention. Indeed, the invention makes a paradigm shift by freeing itself from a relative movement calculation, in which the localization is obtained at each moment by estimating the movement made since the previous localization, and which is naturally subject to a drift phenomenon induced by the accumulation of errors. In the present case, the localization is provided in a frame of reference linked to the wall 20a, 20b, which represents a tangible, reliable and substantially immobile element with respect to the vehicle 1. It should be noted that this frame of reference is particularly simple given that the wall 20a, 20b has a known geometry which does not require precise mapping. Also, the use of the different sensors, which can be of different types, is decoupled along each of the axes of the frame of reference: each sensor makes it possible to recalibrate the localization by providing information along one (or more) axis (axes) of the frame of reference, independently of the other sensors.

Furthermore, unlike the known devices which are based on an estimation of the relative movement of the vehicle 1, in this case there is no initiation problem, since the localization of the vehicle 1 is self-initiated along each axis by measuring its distance from the wall 20a, 20b (for the X axis), its distance from the terminal 21 (for the Y axis) and its distance from the floor and/or ceiling 20c (for the Z axis).

In a particularly advantageous manner, it is sufficient to arbitrarily place a terminal 21 and the vehicle 1 in the vicinity of the wall for the vehicle 1 to self-initiate.

In other words, the method according to the invention makes it possible to avoid the failures associated with a localization strategy which relies exclusively on the estimation of the relative movement of the vehicle 1. In this case, the localization relates to fixed objects: the wall 20a, 20b, the floor and/or the ceiling 20c and one or more fixed terminals 21.

Thus, the invention proposes a simplified, minimalist localization method compared to traditional methods, while being more reliable in the context of the localization of a vehicle moving in the vicinity of a wall. Indeed, the method according to the invention offers a reliable localization, in which the localization on the Y axis can be based solely on a distance measurement with respect to a terminal, the localization on the X axis can be based solely on a distance measurement with respect to the wall, and, in the case of a flying vehicle, the localization on the Z axis can be based solely on a distance measurement with respect to the floor.

Furthermore, the determination of an orientation about the vertical axis is carried out by comparing the distance measurement with respect to the wall 20a, 20b from at least two distance sensors 15a, 15b (arranged on the same side) of the vehicle 1.

This is a particularly advantageous measure of the invention.

Indeed, if the vehicle 1 is oriented parallel to the wall 20a, 20b, the two sensors 15a or 15b measure the same distance. Otherwise, a measurement deviation can be used to determine an orientation offset about the Z axis. This particularly simple arrangement is made possible by the advantageous use of a Frenet frame of reference linked to the wall 20a, 20b. It should be noted that, in order to further increase the accuracy and reliability of the calculation of the orientation about the vertical axis, the data from the inertial unit 11 of the vehicle 1 can be merged with the data relating to the distance with respect to the wall 20a, 20b. This merging can be carried out using a state estimator filter (such as a Kalman filter) to calculate the orientation about the Z axis from the various data collected.

As described above, the distance measurement on the transverse axis X can be carried out by sonars on board the vehicle 1.

Sonars are a particularly suitable choice for performing distance measurements with respect to a wall 20a, 20b which, in the case of a logistics warehouse, may have irregularities, recesses and consist of elements that can interfere with magnetic radiation. Again, to further increase the accuracy and robustness of the positioning, the data from the inertial unit 11 of the vehicle 1 and/or the visual data provided by the possible optical flow sensor 17 can be merged with the sonar data. This arrangement also makes it possible to provide information redundancy in the event of a sensor malfunction. The data merging makes it possible to combine the proprioceptive data from the inertial unit 11 with the exteroceptive data from the sonars and/or the optical flow sensor 17. The merging can be carried out using a state estimator filter (such as a Kalman filter), to calculate the position and the speed on the X axis from the various data collected.

Likewise, the positioning along the vertical axis Z is carried out with the sensor for detecting the distance from the floor and/or the ceiling 20c and/or by using a barometer integrated into the vehicle 1. Once again, to further increase the reliability of the positioning along the vertical axis Z, the data from the inertial unit 11 of the vehicle 1 can also be used redundantly and a state estimator filter can be used to calculate the position and speed along the Z axis from the various data collected.

The position along the longitudinal axis Y can be measured by means of the sensor 16, in particular an ultra-wideband sensor. According to a particular arrangement, this sensor communicates with the terminal 21. In addition, it is possible to use visual landmarks (passive such as patterns or active such as “Li-Fi” devices for communication via a light wave) to enhance the longitudinal positioning. It is understood that a single terminal 21 may be sufficient to determine the position along the longitudinal axis Y, which contrasts with the known techniques of localization by terminals, which involve at least three terminals and require complex triangulation.

Again, to further increase the accuracy and robustness of the positioning along the longitudinal axis Y, the data from the inertial unit 11 of the vehicle 1 and/or the visual data provided by the possible optical flow sensor 17 can be merged with the data from the sensor 16. The data merging makes it possible to combine the proprioceptive data from the inertial unit 11 with the exteroceptive data from the sensors 16 and 17. The merging can be carried out using a state estimator filter (such as a Kalman filter), to calculate the position and the speed on the Y axis from the various data collected.

In a particularly advantageous manner, it is possible to position the vehicle 1 relative to a second wall 20a, 20b, by using the additional transverse distance sensors 15b. As described above, according to this arrangement, the vehicle 1 has at least two transverse distance sensors 15a along a first flank and another transverse distance sensor 15b along a second flank opposite to the first flank. This arrangement advantageously allows the vehicle 1 to position itself relative to the two walls 20a and 20b of an aisle of a logistics warehouse.

### Navigation Method

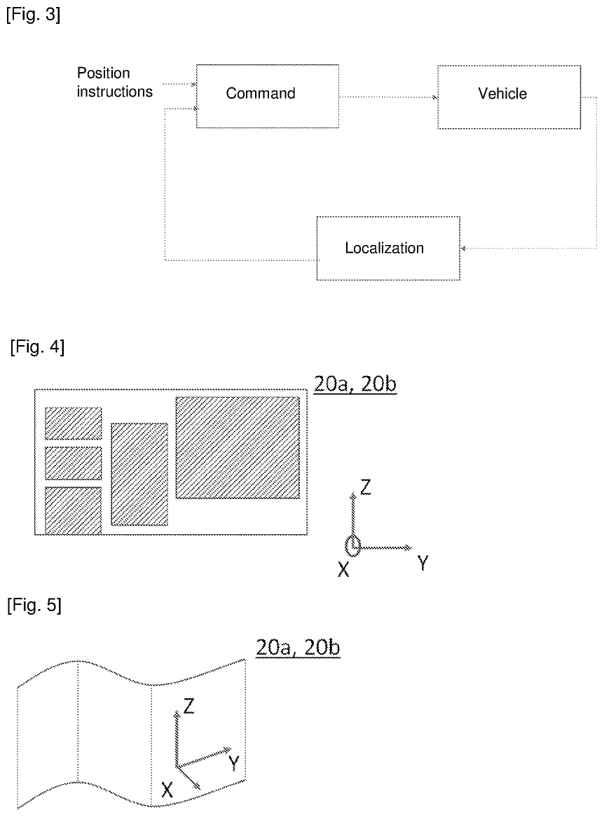

The invention also relates to a navigation method which is based on the localization method, as shown in a diagram in FIG. 3. First, the localization of the vehicle 1 is acquired. Then, on the basis of a position instruction, a command is sent to the actuators of the vehicle. In a cyclic manner, this servo loop allows the drone's position to be regulated so that it respects the position instructions sent to it.

In a particularly advantageous manner, the desired movement of the vehicle can be modeled by a series of translations and can thus be transmitted as a set of position instructions.

1. Localization method for a vehicle (1) moving in the vicinity of a wall (20a, 20b), with a localization frame of reference, defined at the point of projection of the vehicle (1) on the wall (20a, 20b), comprising a horizontal longitudinal axis (Y) tangent to the wall (20a, 20b), a vertical axis (Z) and a transverse axis (X) defined such that the frame of reference is a direct orthonormal frame of reference, the method being characterized in that it comprises localization along the transverse axis (X) on the basis of measurements of a distance between the vehicle (1) and the wall (20a, 20b) provided by at least one transverse distance sensor (15a, 15b) of the vehicle (1), and localization along the longitudinal axis (Y) on the basis of measurements of a distance between the vehicle (1) and a fixed terminal (21) provided by at least one longitudinal distance sensor (16) of the vehicle (1).

2. Localization method according to claim 1, further comprising localization along the vertical axis (Z) on the basis of altitude measurements provided by altitude measuring means (13, 14) of the vehicle (1) and/or vertical distance measurements from the ceiling provided by vertical distance measuring means.

3. Localization method according to claim 1, further comprising determining an orientation of the vehicle (1) relative to the wall (20a, 20b) along the vertical axis (Z) by comparing the distance measurements between the vehicle (1) and the wall (20a, 20b) provided by at least two transverse distance measurements (15a, 15b) of the vehicle (1) obtained at different positions or in different orientations.

4. Localization method according to claim 1, wherein each transverse distance measurement (15a, 15b) is obtained using a sonar or a laser or a depth camera.

5. Localization method according to claim 1, wherein said at least one longitudinal distance sensor (16) is an ultra-wideband sensor or a time-of-flight measurement system communicating with said fixed terminal (21).

6. Localization method according to claim 2, wherein the altitude measuring means (13, 14) of the vehicle (1) comprise at least one vertical distance sensor (13) which measures the distance between the vehicle (1) and the floor and/or the ceiling, and/or a barometer (14).

7. Localization method according to claim 2, wherein the localization along an axis from among the transverse axis (X), the longitudinal axis (Y) or the vertical axis (Z) is also based on inertial data provided by an inertial unit (11) of the vehicle (1).

8. Localization method according to claim 2, wherein the localization along a pair of axes from among the transverse axis (X), the longitudinal axis (Y) or the vertical axis (Z) is also based on visual data provided by a camera (17) of the vehicle (1), such as an optical flow sensor.

9. Localization method according to claim 1, wherein the vehicle (1) moves in the vicinity of at least two opposing walls (20a, 20b), including a first wall (20a) and a second wall (20b), the localization along the transverse axis (X) being based on distance measurements between the vehicle (1) and the first wall (20a) provided by at least a first transverse distance sensor (15a) of the vehicle (1), and/or distance measurements between the vehicle (1) and the second wall (20b) provided by at least one second transverse distance sensor (15b) of the vehicle (1).

10. Localization method according to claim 1, wherein the vehicle (1) moves under a wall (20c) which is opposite a floor and forms a ceiling, with the localization along the vertical axis (Z) being based on altitude measurements provided by altitude measuring means (13, 14) of the vehicle (1) and/or vertical distance measurements from the ceiling (20c) provided by vertical distance measuring means.

11. Navigation method for a vehicle (1), characterized in that it comprises localization of the vehicle (1) according to claim 1, and generation of a command to move the vehicle (1).

12. Navigation method according to claim 11, wherein said movement command comprising a correction of the orientation of the vehicle (1) so as to have only translational movements.

13. Vehicle (1) suitable for implementing a method according to claim 1.

14. Vehicle (1) according to claim 13, selected from a flying drone, a wheeled mobile vehicle, or a mobile watercraft.

15. Computer program product comprising code instructions for executing a localization method according to claim 1 for executing a navigation method in order to allow the localization and/or navigation of a vehicle when the program is executed on a computer.

16. Storage means which is readable by computer equipment and on which a computer program product comprises code instructions for executing a localization method according to claim 1 for executing a navigation method.
